(19) United States
(12) Patent Application Publication
(10) Pub. No.: US 2014/0140355 A1
(43) Pub. Date: May 22, 2014

(54) USING A REST RESOURCE BASE FOR NETWORKED APPLIANCES

(71) Applicant: GENERAL ELECTRIC COMPANY, Schenectady, NY (US)

(72) Inventors: Jeff Donald Drake, Louisville, KY (US); Myles D. Caley, LaGrange, KY (US); Dong Hun Lee, Gunpo-si (KR); Christopher Matthew Baker, Louisville, KY (US)

(73) Assignee: GENERAL ELECTRIC COMPANY, Schenectady, NY (US)

(21) Appl. No.: 13/681,570

(22) Filed: Nov. 20, 2012

(51) Int. Cl. H04L 12/00

(52) U.S. Cl. CPC H04L 12/00
USPC 370/464

(57) ABSTRACT

A system and method of remotely communicating with an appliance system is provided. A remote device, such as a computer, a smartphone, a tablet, etc., can request information associated with a home appliance over a communication network. The information can be stored in a memory of the appliance in a data structure having a plurality of resources organized pursuant to a Representational State Transfer (REST) resource orientated architecture. A representation of a plurality of resources can include a layered structure having a hierarchy having subordinate resources. Each subordinate resource can provide more detailed information. Information relating to a data path needed to read the resource corresponding to the requested information as well as information relating to navigating to subordinate resources if requested can be included in the representation of each resource. The home appliance can provide the remote device a representation of the resource corresponding to the requested information.

### FIELD OF THE INVENTION

The present disclosure relates to networked appliances and more particularly to a networked appliance having a REST resource oriented architecture.

### BACKGROUND OF THE INVENTION

Several appliances can be installed on a single premises such as a residential home, an office building, or a commercial establishment. For instance, a refrigerator, a microwave oven, a cooking appliance having a stove and/or oven, heating and/or cooling systems can be installed. Modern appliances are more sophisticated than their earlier counterparts, and often include microcontrollers or microprocessors that allow a user greater interaction with the appliance. For example, an appliance can be programmed or reprogrammed as well as provide diagnostic information.

The Internet has given rise to worldwide connectivity for many types of devices. However, appliances have traditionally had only standalone capabilities which required operation without cooperation or communication between other devices. As a result, current status information regarding the appliance could not be determined without being physically present at the appliance.

Recently, network adapters have been added to the appliances to provide communications between the appliance and a remote device. However, to achieve bi-directional communication, complex network architectures have been employed requiring complex command structures that use extensive memory and bandwidth.

Thus, a need exists for a system and method for providing improved communication between a networked appliance and a remote device.

### BRIEF DESCRIPTION OF THE INVENTION

Aspects and advantages of the invention will be set forth in part in the following description, or may be apparent from the description, or may be learned through practice of the invention.

One exemplary aspect of the present disclosure is directed to a computer-implemented method of communicating information associated with a home appliance over a network. The method can include receiving, at the home appliance, a request for information from a remote device over the network; accessing a data structure for a plurality of resources stored in a memory of the appliance. The resources are organized pursuant to a REST resource orientated architecture. The method can further include identifying a representation of a resource corresponding to the requested information; and providing the representation of the resource corresponding to the requested information to the remote device over the network.

Another exemplary aspect of the present disclosure is directed to a computer-implemented method of communicating information associated with a home appliance over a network. The method can include requesting the information associated with the home appliance from a remote device over the network; and receiving, at the remote device, a representation of a resource corresponding to the information requested. The representation of a resource is identified based on resources stored in a memory of the appliance and the resources are organized in a data structure pursuant to a REST resource orientated architecture.

Still another exemplary aspect of the present disclosure is directed to a home appliance. The home appliance can include a memory to store resources. The resources are organized in a data structure pursuant to a REST resource orientated architecture. The home appliance can further include a processor coupled to the memory and configured to access the resources, and a network interface device. The network interface device can be configured to receive a request for appliance information over a network from a remote device and to send a representation of a resource corresponding to the request for appliance information to the remote device over the network.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a block diagram of a system for remotely interacting with an appliance system according to an exemplary embodiment of the present disclosure;

FIG. 2 depicts an exemplary data structure according to an exemplary embodiment of the present disclosure; and

FIG. 3 depicts a flow chart of a method according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure relates to a system and method of remotely communicating with an appliance system. A remote device, such as a computer, a smartphone, a tablet, etc., can request information associated with a home appliance over a communication network. The information can be stored in a memory of the appliance in a data structure having a plurality of resources organized pursuant to a Representational State Transfer (REST) resource orientated architecture. A representation of a plurality of resources can include a layered structure having a hierarchy including subordinate resources. Each subordinate resource can provide more detailed information. Information relating to a data path needed to read the resource corresponding to the requested information as well as information relating to navigating to subordinate resources if requested can be included in the representation of each resource. The home appliance can provide the remote device a representation of the resource corresponding to the requested information.

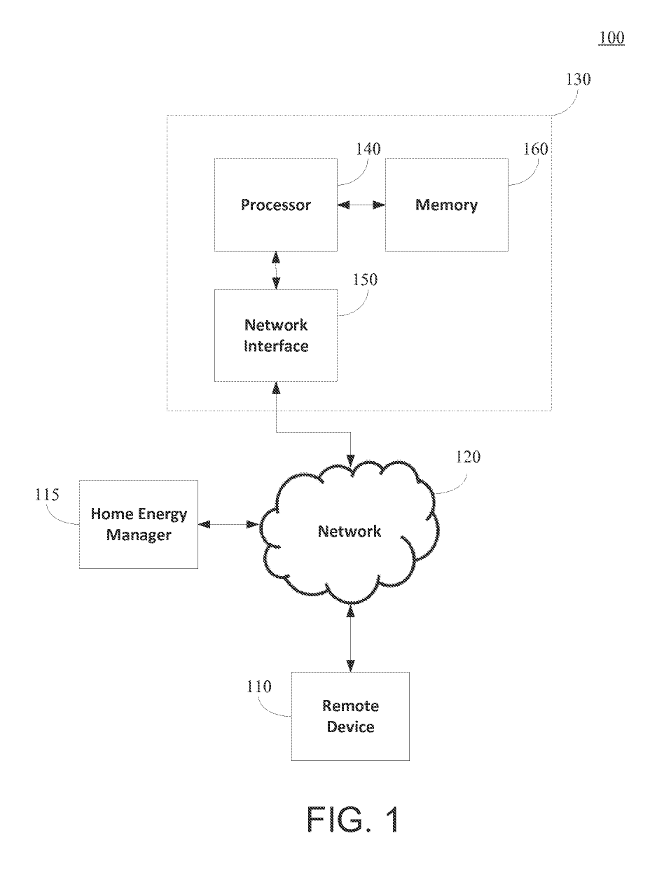

FIG. 1 illustrates an exemplary system 100 for remotely interacting with an appliance according to an exemplary embodiment of the present disclosure. The system 100 can include a remote device 110, a home energy manager 115, a network 120, and a home appliance 130. The home appliance 130 can include a processor 140, a network interface 150 and a memory 160.

Remote device 110 can be any device configured to communicate over a communication network having a processor and a memory. For instance, remote device 110 can include a computer, a smartphone, a tablet, etc. The remote device 110 can include an interface that allows the remote device 110 to initiate communications with appliance 130 over the network 120.

Appliance 130 can be any appliance used on a premises such as a refrigerator, a washer, a dryer, a dishwasher, an air conditioner, a microwave, an oven, a cooktop, a compressor, a soft water filter, a humidifier, an HVAC unit, and a hot water heater. The appliance 130 can include a network interface 150 to couple the appliance with a communication network 120 such that the appliance can transmit and receive information over the network 120. Network 120 can be any wired or wireless network such as a WAN, LAN, and/or HAN.

The remote device 110 can communicate with the appliance 130 directly using the network interface 150 or indirectly such that the home energy manager 115 facilitates transfer of the communications between the remote device 110 and the appliance 130. In one implementation, the remote device 110 can request information associated with a home appliance 130 over a network 120. The appliance 130 can receive the request and provide, to the remote device 110, a representation of a resource indicative of the requested appliance information.

In another implementation of the present disclosure, remote device 110 can initiate communications with the home energy manager 115 to request information corresponding to the appliance. The appliance 130 can initiate communications with the home energy manager 115 over the network 120 using the network interface 150 to receive the request from the remote device 110. The appliance 130 can provide the representation of a resource indicative of the requested information of the appliance to the home energy manager 115. This information can then be sent to or retrieved by the remote device 110 from the home energy manager 115.

The appliance can further include a processor 140 coupled with a memory device 160. Processor 140 can be configured to access information in memory 160 based on a request from a remote device 110 and provide the requested information to the remote device 110. The processor 140 can be positioned in any location with the appliance 130. In addition, processor 140 can be the only processor in the appliance 130 such that processor 140 controls all operations of the appliance. Alternatively, processor 140 can be a sub-processor coupled to the overall appliance processor. If processor 140 is a sub-processor, it can be located with the overall appliance processor or be separate from the overall appliance processor.

By way of example, any/all of the “processors” discussed in this disclosure can include one or more processing devices such as microprocessors, CPUs or the like, such as general or special purpose microprocessors operable to execute programming instructions or micro-control code associated with operation of an appliance 130. In one embodiment, the processor executes programming instructions stored in memory. The memory can represent random access memory such as DRAM, or read only memory such as ROM or FLASH. The memory 160 can be a separate component from the processor or can be included onboard within the processor. Alternatively, the processor might also be constructed without using a microprocessor, using a combination of discrete analog and/or digital logic circuitry (such as switches, amplifiers, integrators, comparators, flip-flops, AND gates, and the like) to perform control functionality instead of relying upon software.

In a particular embodiment of the present disclosure, the processor 140 can receive a signal indicative of a request from the remote device 110 for information associated with the home appliance 130. The information can be stored in the memory 160 of the appliance in a data structure having a plurality of resources organized pursuant to a REST resource orientated architecture. The REST interface can enable the resources to be accessed in a uniform manner by providing a more efficient mechanism to transport a request and corresponding result to the request between the appliance and the remote device.

The processor 140 can identify a representation of a resource indicative of the requested information and provide that representation of the resource to the remote device 110 over the network 120 using network interface 150. Each representation can include information relating to the data path to provide the resource corresponding to the requested information. In addition, the representation may also include navigational information to the subordinate resources to retrieve information from a lower level resource.

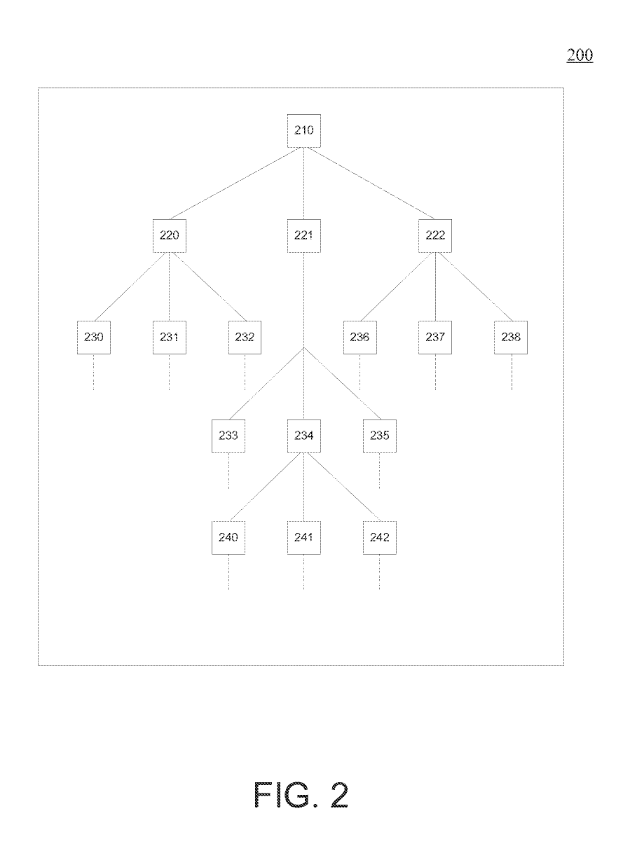

FIG. 2 illustrates a representation of an exemplary data structure 200 for a plurality of resources organized pursuant to the REST architecture. Data structure 200 can be implemented having a layered structure having a top down configuration. For instance, data structure 200 can have a tree hierarchy such that each resource will lead deeper and deeper into subsystems and components of the appliance. This structure can allow the applications consuming these resources to rely on the self-describing nature of the subsystems and components. Since the resources are self-describing, the information requested from a remote device can be provided without any additional software because the resources are readable and expandable in a way that does not require additional software.

As illustrated in FIG. 2, a top-most resource 210 can correspond to the specific home appliance. First subordinate resources 220, 221, and 222 can correspond to subsystems and/or components of the appliance. Each subordinate resource can have a plurality of related subordinate resources 230-238 relating to subsystems and/or components of the superior subsystems and/or components. Additional subordinate resources 240-242 can depend from superior or higher-level subordinate resources. The data structure 200 can include any number of subordinate resource layers as well as any number of subordinate resources depending from each superior subordinate resource based on subsystems and components of the home appliance.

In one implementation of the present disclosure, a user can initiate communications with an appliance from a remote device to request information, such as finding out diagnostic information. For example, an internet web browser can be used. Each appliance can correlate to a specific url or webpage specifically for the appliance. The user can navigate all subsystems and/or components of the appliance using the single webpage corresponding to the appliance. When the user is directed to the related appliance web page, a list is provided to the user to select the desired information to request from the appliance. This list can be provided in any type of format, such as a pull down menu, icons, etc. After each selection from the list provided, the user is presented with a further list of more detailed information to request until the desired information to request is selected.

For example, if a technician wanted to find out the status of a refrigerator's ice maker water solenoid, the information could be presented to the technician as follows:
Browse->/user account—responds with a list of devices on the account
Browse->/user account/refrigeration—responds with a list of: Browse->refrigeration models on this account
Browse->/user account/refrigeration/model xyz—respond with a list of: Browse->sub systems of this refrigerator
Browse->/user account/refrigeration/model xyz/freezer/user account/refrigeration/model xyz/refrigerator
Browse->/user account/refrigeration/model xyz/freezer/set temp/user account/refrigeration/model xyz/freezer/actual temp/user account/refrigeration/model xyz/freezer/ice maker/user account/refrigeration/model xyz/freezer/components
Browse->/user account/refrigeration/model xyz/freezer/ice maker/components
Browse->/user account/refrigeration/model xyz/freezer/ice maker/components/water/user account/refrigeration/model xyz/freezer/ice maker/components/extraction
Browse->/user account/refrigeration/model xyz/freezer/ice
Browse->maker/components/water/solenoid
Browse->/user account/refrigeration/model xyz/freezer/ice maker/components/water/solenoid/status

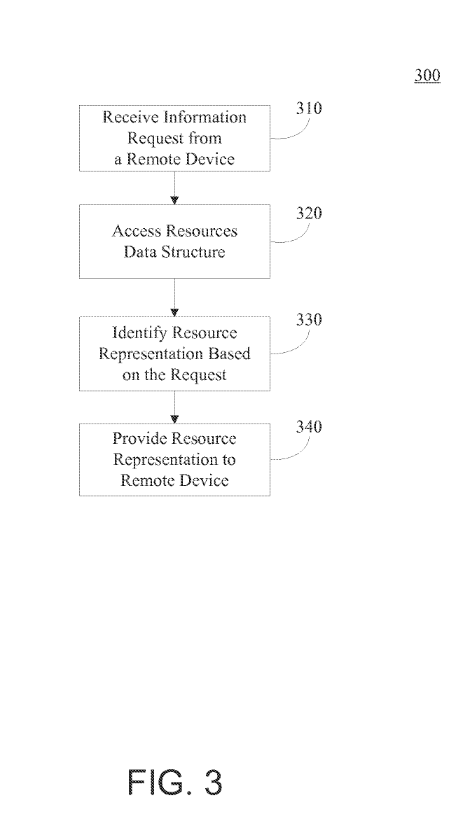

FIG. 3 illustrates a flow chart of exemplary method 300 according to exemplary embodiments of the present disclosure. The method 300 can be implemented with any suitable home appliance network system, such as the system illustrated in FIG. 1. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (310), a request for information is received from a remote device. An appliance can access a data structure for a plurality of stored resources at (320), where the resources are organized pursuant to a REST resource orientated structure. A corresponding resource representation can be identified based on the request from the remote device at (330) and the appliance can provide the remote device with the resource representation of indicative of the information requested at (340).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer-implemented method of communicating information associated with a home appliance over a network, comprising:
receiving, at the home appliance, a request for information from a remote device over the network;
accessing a data structure for a plurality of resources stored in a memory of the appliance, the resources organized pursuant to a Representational State Transfer (REST) resource orientated architecture;
identifying a representation of a resource corresponding to the requested information; and
providing the representation of the resource corresponding to the requested information to the remote device over the network.

2. The computer-implemented method as in claim 1, wherein the representation of the resource includes data path information to read the resource corresponding to the requested appliance information and navigation information to subordinate resources in the REST resource orientated architecture to retrieve next level information.

3. The computer-implemented method as in claim 1, wherein the representation of a resource corresponding to the requested appliance information includes a representation of a plurality of resources.

4. The computer-implemented method as in claim 3, wherein the representation of a plurality of resources has a layered structure having a top down configuration.

5. The computer-implemented method as in claim 4, wherein the layered structure includes a hierarchy having subordinate resources, each subordinate resource having more detailed information relative to a superior resource.

6. The computer-implemented method as in claim 1, wherein the network is a home area network.

7. A computer-implemented method of communicating information associated with a home appliance over a network, comprising:
requesting the information associated with the home appliance from a remote device over the network; and
receiving, at the remote device, a representation of a resource corresponding to the information requested,
wherein the representation of a resource is identified based on resources stored in a memory of the appliance and the resources are organized in a data structure pursuant to a Representational State Transfer (REST) resource orientated architecture.

8. The computer-implemented method as in claim 7, further comprising accessing the information from the remote device using the representation of the resource.

9. The computer-implemented method as in claim 7, wherein the representation of the resource includes data path information to read the resource corresponding to the information requested and navigation information to subordinate resources in the REST resource oriented architecture to retrieve next level information.

10. The computer-implemented method as in claim 7, wherein the representation of a resource corresponding to the information requested includes a representation of a plurality of resources.

11. The computer-implemented method as in claim 10, wherein the representation of a plurality of resources has a layered structure having a top down configuration,

12. The computer-implemented method as in claim 11, wherein the layered structure includes a hierarchy including subordinate resources, each subordinate resource having more detailed information relative to a superior resource.

13. A home appliance, comprising:
a memory to store resources, the resources organized in a data structure pursuant to a Representational State Transfer (REST) resource orientated architecture;
a processor coupled to the memory and configured to access the resources; and
a network interface device, the network interface device configured to receive a request for appliance information over a network from a remote device and to send a representation of a resource corresponding to the request for appliance information to the remote device over the network.

14. The home appliance as in claim 13, wherein the representation of the resource includes data path information to read the resource corresponding to the requested appliance information and navigation information to subordinate resources in the REST resource oriented architecture to retrieve next level information.

15. The home appliance as in claim 13, wherein the representation of a resource corresponding to the requested appliance information includes a representation of a plurality of resources.

16. The home appliance as in claim 15, wherein the representation of a plurality of resources has a layered structure having a top down configuration.

17. The home appliance as in claim 16, wherein the layered structure includes subordinate resources, each subordinate resource having more detailed information relative to a superior resource.

18. The home appliance as in claim 13, wherein the appliance information includes information regarding a state of the appliance.

19. The home appliance as in claim 13, wherein the appliance is at least one of a refrigerator, a washer, a dryer, a dishwasher, an air conditioner, a microwave, an oven, a cooktop, a compressor, a soft water filter, a humidifier, an HVAC unit, and a hot water heater.
